(19) United States
(12) Patent Application Publication
(10) Pub. No.: US 2010/0270154 A1
(43) Pub. Date: Oct. 28, 2010

(54) GAS SENSOR ELEMENT, GAS SENSOR EQUIPPED WITH GAS SENSOR ELEMENT, AND METHOD OF PRODUCING GAS SENSOR ELEMENT

(75) Inventors: Yasufumi Suzuki, Kariya-shi (JP); Masatoshi Ikeda, Aichi-ken (JP)

Correspondence Address: NIXON & VANDERHYE, PC, 901 NORTH GLEBE ROAD, 11TH FLOOR, ARLINGTON, VA, 22203, US

(73) Assignees: DENSO CORPORATION, Kariya-city (JP); NIPPON SOKEN, INC., Nishio-city (JP)

(21) Appl. No.: 12/765,132

(22) Filed: Apr. 22, 2010

(30) Foreign Application Priority Data
Apr. 23, 2009 (JP) 2009-105003

(51) Int. Cl. G01N 27/28; B32B 38/00

(52) U.S. Cl. 204/424; 156/89.12

(57) ABSTRACT

A gas sensor element has a solid electrolyte with an oxygen ion conductivity, a target gas electrode formed on one surface of the solid electrolyte, a reference gas electrode formed on the other surface of the solid electrolyte, a porous diffusion resistance layer through which the target gas passes to reach the target gas electrode, and a catalyst layer formed on an outer surface of the porous diffusion resistance layer. Through the catalyst layer, the target gas is introduced to the inside of the gas sensor element. The target gas electrode is formed around the porous diffusion resistance layer. The catalyst layer contains noble metal catalysts. The noble metal catalysts contain at least rhodium and palladium. The noble metal catalysts have an average particle size of not less than 0.3 μm.

### CROSS-REFERENCE TO RELATED APPLICATION

This application is related to and claims priority from Japanese Patent Application No. 2009-105003 filed on Apr. 23, 2009, the contents of which are hereby incorporated by reference.

### BACKGROUND OF THE INVENTION

1. Field of the Invention

The present invention relates to gas sensor elements, gas sensors equipped with the gas sensor element therein capable of detecting a concentration of a specific gas contained in a target gas, and a method of producing the gas sensor element.

2. Description of the Related Art

There are various types of gas sensor elements which are widely known and used in various technical fields. FIG. 5 is a cross section showing a catalyst layer in a conventional gas sensor element. FIG. 6A is a view to explain a state where a target gas is passing through a trap layer and the catalyst layer in the conventional gas sensor element. FIG. 6B is a view to explain a state where the target gas reaches a target gas chamber in the conventional gas sensor element.

For example, as shown in FIG. 5, FIG. 6A, and FIG. 6B, one type of those conventional gas sensor elements is comprised of a solid electrolyte 911, a target gas electrode 912, a reference gas electrode 913, a porous diffusion resistance layer 914, and a catalyst layer 92. The solid electrolyte 911 has a oxygen ion conductivity. The target gas electrode 912 is formed on one surface of the solid electrolyte 911. The reference gas electrode 913 is formed on the other surface of the solid electrolyte 911. In particular, as shown in FIG. 6A and FIG. 6B, the porous diffusion resistance layer 914 surrounds the target gas electrode 912. The target gas to be detected passes through the porous diffusion resistance layer 914, and reaches the target gas electrode 912.

However, the conventional gas sensor element 9 has the following drawback. That is, H₂ gas contained reaches the target gas electrode 912 in the target gas chamber 940 earlier than other gases contained in an exhaust gas as a target gas because H₂ gas has a light molecular weight and moves at high speed through the inside of the porous diffusion resistance layer 914 when compared with other gases such as O₂ gas contained in the target gas to be detected. This makes it for the gas sensor element 9 to output an incorrect detection signal which is away from a true detection signal regarding a concentration of a specific gas contained in the target gas.

For example, there is a tendency to increase the amount of H₂ gas contained in an exhaust gas which is emitted from a direct injection engine during the working of the engine in addition to the engine start to work because of having a different combustion mechanism from other types of the engines. Further, there is also a tendency to increase the amount of H₂ gas contained in the exhaust gas emitted from CNG (compressed natural gas) engines because of having a different fuel composition when compared with that of the gasoline engines. Therefore those engines have a problem where the gas sensor element outputs an incorrect detection signal, regarding the concentration of a specific gas, which is different from a true detection signal based on the presence of H₂ gas contained in a target gas because H₂ gas passes at a high speed in the porous diffusion layer rather than other gases.

In order to solve the above conventional problem, as shown in FIG. 6, conventional techniques have proposed various types of gas sensor elements. For example, one conventional gas sensor element 9 has the catalyst layer 92 formed on the outer surface of the porous diffusion resistance layer 914. The catalyst layer 92 contains platinum and palladium. Japanese patent laid open publication No. JP 2007-499046 discloses such a conventional gas sensor element capable of preventing an incorrect detection which is away from a true detection value.

However, this conventional gas sensor element 9 disclosed in JP 2007-199046 has the following problem. That is this conventional gas sensor element can prevent an incorrect detection which is away from its true detection of the target gas, but there is a probability of deteriorating the noble metal catalysts 921 in the catalyst layer 92 under some environments using the gas sensor equipped with the gas sensor element.

That is, the catalyst layer 92 in such a conventional gas sensor element contains the noble metal catalysts 921 of a small average particle size of not more than 0.1 μm. There is a probability to deteriorate the catalyst capability of the catalyst layer 92 because the noble metal catalysts 921 are coagulated and vaporized under cyclic thermal stress.

Therefore there is a strong demand to provide an improved gas sensor element capable of preventing outputting an incorrect detection signal which is away from a true detection signal and also preventing deterioration of the catalyst layer in the gas sensor element.

### SUMMARY OF THE INVENTION

It is an object of the present invention to provide a gas sensor element having a catalyst layer with high durability, which is capable of preventing occurrence of outputting an incorrect detection signal which is away from a true output.

In accordance with a first aspect of the present invention, there is provided a gas sensor element having a solid electrolyte with an oxygen ion conductivity, a target gas electrode formed on one surface of the solid electrolyte, a reference gas electrode formed on the other surface of the solid electrolyte, a porous diffusion resistance layer capable of permeating the target gas and surrounding the target gas electrode, and a catalyst layer. This catalyst layer is formed on an outer surface of the porous diffusion resistance layer. Through the catalyst layer, the target gas is introduced into the inside of the gas sensor element. In particular, the catalyst layer contains noble metal catalysts of an average particle size of not less than 0.3 μm.

In accordance with a second aspect of the present invention, there is provided a gas sensor which is equipped with the gas sensor element according to the first aspect of the present invention.

In accordance with a third aspect of the present invention, there is provided a method of producing the gas sensor element according to the first aspect of the present invention. In the method of the third aspect of the present invention, a catalyst paste is printed on an outer surface of the ceramics sheet of the porous diffusion resistance layer in order to make a catalyst layer on the outer surface of the porous diffusion resistance layer.

In the gas sensor element according to the first aspect of the present is invention, the average particle size of the noble metal catalysts in the catalyst layer is not less than 0.3 μm. This makes it possible to provide the gas sensor element having the catalyst layer with superior high durability.

On the other hand, noble metal catalysts having a small particle size which is not more than 0.1 μm are supported in conventional gas sensor elements. In the prior art, it has been thought that using noble metal catalysts of a small average particle size, for example, which is not more than 0.1 μm supported on ceramics such as alumina can adequately show its catalyst function. The reason why the noble metal catalysts of such a small average particle size are used in the catalyst layer of the conventional gas sensor elements is as follows:

(a) The more the average particle size of noble metal catalysts in a catalyst layer is increased, the more the surface of the noble metal catalysts to show the catalyst activity is decreased; and

(b) Unless increasing the content of the noble metal catalysts in the catalyst layer, it is difficult to obtain an adequate catalyst activity.

However, noble metal catalysts of such a small average particle size contained in the catalyst layer of the conventional gas sensor elements are coagulated and vaporized under a severe condition to repeat cyclic thermal stress. The conventional gas sensor elements cannot maintain the durability of the catalyst layer.

On the other hand, the inventors according to the present invention have invented the gas sensor element having the catalyst layer which contains noble metal catalysts by changing the average particle size of the noble metal catalysts, which is different from an average particle size of noble metal catalysts used in the conventional gas sensor elements. That is, the inventors have noticed and improved, using the noble metal catalysts which have a relatively large average particle size rather than that of the conventional gas sensor element. The structure of the gas sensor element of the present invention makes it possible to suppress the noble metal catalysts from being coagulated and vaporized even under severe environments. In other words, using the noble metal catalysts of the average particle size within an optimum range (which is different from that of the conventional gas sensor element) makes it possible to suppress the noble metal catalysts from being coagulated and vaporized under various severe conditions such as high temperature conditions. It is thereby possible for the present invention to provide the gas sensor element having the catalyst layer with superior high durability under various severe environments such as high temperature conditions.

Because the gas sensor element according to the first aspect of the present invention has the catalyst layer which contains the above noble metal catalysts of a relatively large average particle size, it is possible to carry out an adequate combustion of H₂ gas contained in a target gas. Further, this makes it possible to prevent outputting an incorrect detection signal which is away from its true detection signal.

As described above, according to the first aspect of the present invention, it is possible to provide the gas sensor element having the catalyst layer with high durability, capable of preventing outputting an incorrect detection signal which is away from its true detection signal.

According to the second aspect of the present invention, it is possible to provide the gas sensor equipped with the gas sensor element having the catalyst layer with high durability, which is capable of preventing outputting an incorrect detection signal which is away from its true detection signal.

In the method according to the third aspect of the present invention, the catalyst layer is formed by printing the catalyst paste on the outer surface of the porous diffusion resistance layer. This method to print or apply the catalyst paste on the outer surface of the porous diffusion resistance layer can easily form the catalyst layer on a desired position by a simple method. The catalyst paste to be used by the method of the present invention contains noble metal catalysts of an average particle size of not less than 0.3 μm. This makes it possible to easily produce the gas sensor element having the catalyst layer with superior high durability and with low manufacturing cost.

### BRIEF DESCRIPTION OF THE DRAWINGS

A preferred, non-limiting embodiment of the present invention will be described by way of example with reference to the accompanying drawings, in which:

FIG. 1 is a cross section mainly showing a catalyst layer in a gas sensor element according to a first embodiment of the present invention;

FIG. 2 is a cross section showing the gas sensor equipped with the gas sensor element shown in FIG. 1 along its longitudinal direction;

FIG. 3 is a cross section showing the gas sensor element in a direction which is perpendicular to the axial direction of the gas sensor element according to the first embodiment of the present invention;

FIG. 4 is a view to explain an introduction passage of a target gas which is introduced through the catalyst layer into the inside of the gas sensor element according to the first embodiment of the present invention;

FIG. 5 is a cross section showing a catalyst layer in a conventional gas sensor element;

FIG. 6A is a view to explain a state where a target gas is passing through a trap layer and the catalyst layer in the conventional gas sensor element;

FIG. 6B is a view to explain a state where the target gas reaches a target gas electrode in a target gas chamber in the conventional gas sensor element; and

FIG. 7 is a flow chart showing a method of producing the gas sensor element according to the present invention.

### DETAILED DESCRIPTION OF THE PREFERRED EMBODIMENTS

Hereinafter, various embodiments of the present invention will be described with reference to the accompanying drawings. In the following description of the various embodiments, like reference characters or numerals designate like or equivalent component parts throughout the several diagrams.

### PREFERRED EMBODIMENTS ACCORDING TO THE PRESENT INVENTION

There are in general various types of gas sensor elements such as A/F sensor elements, O₂ sensor elements, and NOx sensor elements. The A/F sensor element is incorporated in an A/F sensor which is placed in an exhaust gas passage of an internal combustion engine such as vehicle engines. The A/F sensor is used in an exhaust gas feedback system. The O₂ sensor element detects a concentration of O₂ gas contained in an exhaust gas emitted from an internal combustion engine. The NOx sensor detects a concentration of air pollutant such as NOx. This NOx sensor is used to detect deterioration of a three-way catalyst placed in an exhaust gas passage.

When the noble metal catalysts in the catalyst layer of the gas sensor element have an average particle size of less than 0.3 μm, it cannot be said that the average particle size is adequately large. The use of the gas sensor element under severe conditions makes it difficult to maintain the durability of the catalyst layer because the noble metal catalysts are coagulated and vaporized under cyclic thermal stress.

Further, it is possible to apply the gas sensor equipped with the gas sensor element according to the present invention to various types of internal combustion engines such as diesel engines and cogeneration engines.

In the first aspect of the present invention, it is preferable for the noble metal catalysts to have an average particle size of not more than 0.8 μm and not less than 0.3 μm. Because this makes it possible to form the catalyst layer of a relatively thin thickness, it is possible to miniaturize the gas sensor element. Using the noble metal catalysts having an average particle size of not more than 0.8 μm makes it possible to obtain the actions and effects of the present invention without increasing the amount of the noble metal catalysts. This can suppress the cost to manufacture the gas sensor element.

On the other hand, because the particle size of the noble metal catalysts is too large when the average particle size of the noble metal catalysts is more than 0.8 μm, it would be difficult to decrease the thickness of the catalyst layer composed of the noble metal catalysts.

It is preferable that the content of the noble metal catalysts is not less than 20 mass % to the entire content of the catalyst layer. Because the catalyst layer has an adequate content of the noble metal catalysts, it is possible to prevent outputting an incorrect detection signal which is away from its true detection signal and to provide the gas sensor element having the catalyst layer with high durability.

On the other hand, because it cannot be said that the average particle size is adequately large when the content of the noble metal catalysts is less than 20 mass %, there is a possibility of it being difficult to obtain the gas sensor element having the catalyst layer with superior high durability.

Further, it is preferable for the catalyst layer in the gas sensor element to have the noble metal catalysts within a range of 20 to 80 mass % to the entire content of the catalyst layer, and ceramics made of α-alumina. This makes it possible for the porous diffusion resistance layer and the catalyst layer which is in contact with the porous diffusion resistance layer to approximately have the same thermal expansion coefficient. This can prevent the catalyst layer from being separated from the porous diffusion resistance layer based on a difference in thermal expansion coefficient between them.

In addition, it is preferable for α-alumina in the catalyst layer to have the average particle size within a range of 0.5 to 2.0 μm. This case makes it possible to provide the gas sensor element with superior response characteristics to the change of an exhaust gas as the target gas to be detected while maintaining the strength of the catalyst layer.

On the other hand, when the average particle size of α-alumina is less than 05 μm, there is a probability to have a dense catalyst layer because the particle size of α-alumina is too small. This makes it difficult to introduce an adequate amount of the target gas into the inside of the gas sensor element, and difficult to provide the gas sensor element with superior sensor response characteristics.

Further, when the average particle size of α-alumina is more than 2.0 μm, the porosity of the catalyst layer is too large because α-alumina has a large particle size, it is impossible to maintain the strength of α-alumina.

It is preferable for the catalyst layer to have a porosity of not less than that of the porous diffusion resistance layer in the gas sensor element. This makes it possible to supply an adequate amount of the target gas to be detected to the inside of the porous diffusion resistance layer after the target gas is passing through the catalyst layer. It is thereby possible to provide the gas sensor element with superior response characteristics.

It is preferable to use the catalyst layer which contains borosilicate glasses within a range of 12 to 40 mass % to the entire content of the catalyst layer. This makes it possible to increase adhesion between the catalyst layer and the porous diffusion resistance layer. As a result it is possible to prevent the catalyst layer from being separated from the porous diffusion resistance layer.

On the other hand, when the content of borosilicate glasses is less than 12 mass %, because it cannot be said for the catalyst layer to have an adequate amount of borosilicate glasses, there is a possibility to improve adhesion between the catalyst layer and the porous diffusion resistance layer.

When the content of borosilicate glasses is more than 40 mass %, because the porosity of the catalyst layer is decreased, there is a possibility to deteriorate the response characteristics of the gas sensor element.

According to the second aspect of the present invention, it is preferable to apply the gas sensor equipped with the gas sensor element according to the present invention to various types of engines such as direct injection engines, turbo engines, and compressed natural gas engines, where the direct injection engine directly injects fuel into combustion chambers, the turbo engine is equipped with an exhaust gas turbine supercharger, and the compressed natural gas engine uses compressed natural gas.

This makes it possible to show the superior features of the gas sensor element previously described in those engines. That is, because those engines discharge an exhaust, gas, in particular, which contains H₂ gas, the use of the gas sensor equipped with the gas sensor element according to the present invention in those engines can show its specific features previously described and can prevent any incorrect detection which is away from its correct detection.

A description will be given of various embodiments of the present invention. However, the concept of the present invention is not limited by the following embodiments.

### First Embodiment

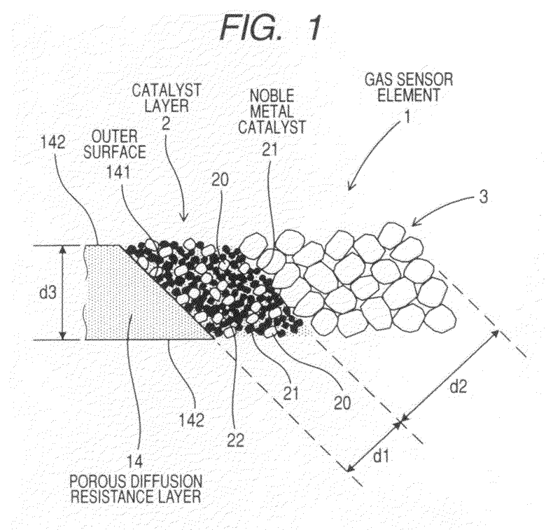

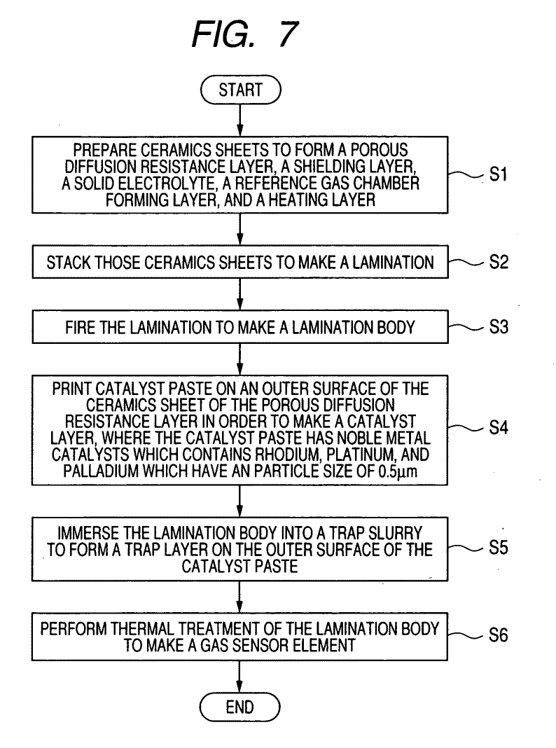

A description will now be given of a gas sensor element, a gas sensor equipped with the gas sensor element, and a method of producing the gas sensor element according to, the first embodiment of the present invention with reference to FIG. 1 to FIG. 4, and FIG. 7.

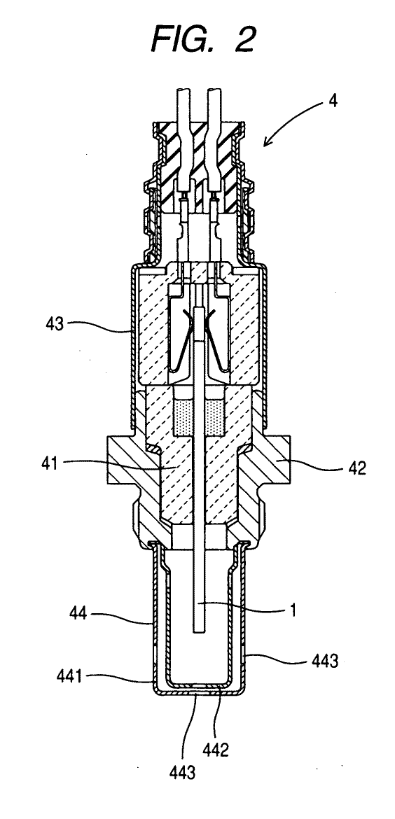

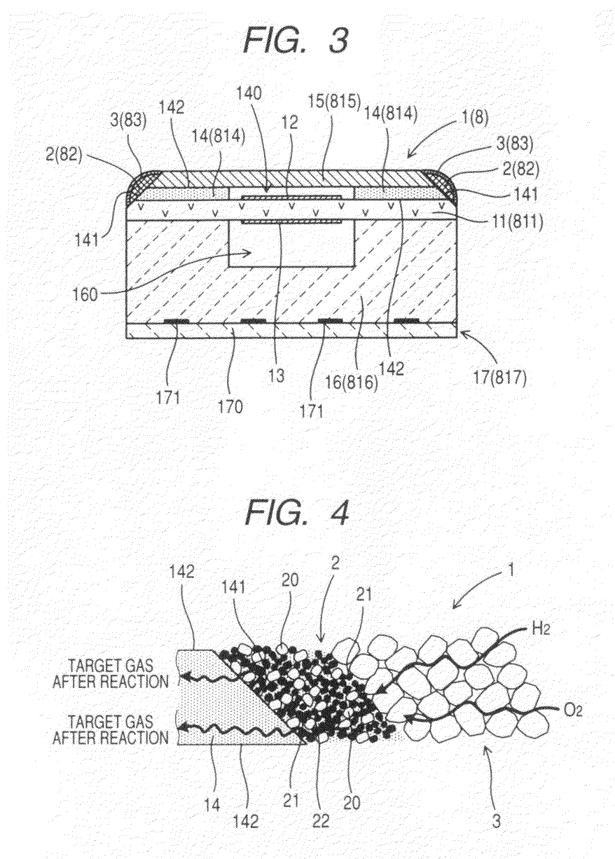

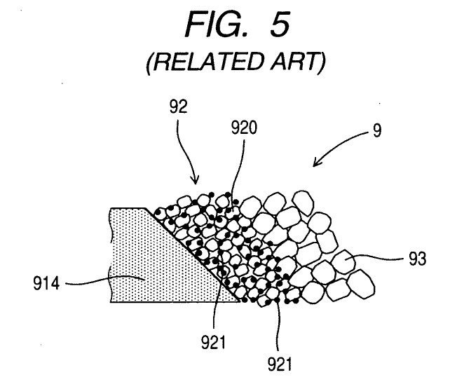

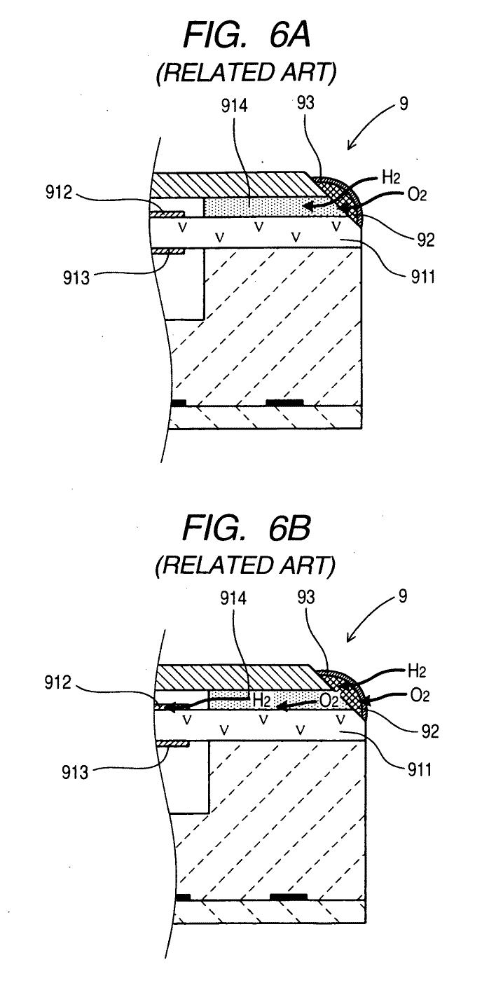

FIG. 1 is a cross section showing the catalyst layer 2 in the gas sensor element 1 according to the first embodiment of the present invention. FIG. 2 is a cross section showing the gas sensor element 1 along its longitudinal direction according to the first embodiment. FIG. 3 is a cross section showing the gas sensor element 1 in a direction which is perpendicular to the axial direction of the gas sensor element according to the first embodiment.

The gas sensor element 1 and the gas sensor 4 equipped with the gas sensor element 1 will be explained.

As shown in FIG. 3, the gas sensor 4 is equipped with the gas sensor element 1. The gas sensor element 1 according to the first embodiment is comprised of a solid electrolyte 11, a target gas electrode 12, a reference gas electrode 13, a porous diffusion resistance layer 14, and the catalyst layer 2. The solid electrolyte 11 has oxygen ion conductivity. The target gas electrode 12 is formed on one surface of the solid electrolyte 11. The reference gas electrode 13 is formed on the other surface of the solid electrolyte 11. As shown in FIG. 3, the porous diffusion resistance layer 14 surrounds the target gas electrode 12. Through the porous diffusion resistance layer 14, the target gas to be detected passes and reaches the target gas electrode. The catalyst layer 2 is formed on the outer surface 141 of the porous diffusion resistance layer 14 through which the target gas is introduced into the inside of the gas sensor element 1. The catalyst layer 2 contains noble metal catalysts 21. In the gas sensor element 1 according to the first embodiment, the average particle size of the noble metal catalysts 21 is not less than 0.3 μm.

As shown in FIG. 2, the gas sensor 4 further has an insulator 41 and a housing 42, an atmosphere cover case 43, and an element cover case 44. The insulator 41 accommodates the gas sensor element 1 and supports it in the inside thereof. The housing 42 accommodates the insulator 41 and supports it in the inside thereof. The atmosphere cover case 43 is caulked to maintain and fix the housing 42 to the inner diameter direction at a base side of the housing 42. The element cover case 44 is placed at the front end part of the housing 42 to protect the gas sensor element 1 from damage from outside.

The element cover case 44 is a multiple structure cover case which is composed of an outer cover case 441 and an inner cover case 442. The outer cover case 441 and the inner cover case 442 have introduction through holes 443 which are formed at the side surface and the bottom surface thereof.

It is possible to apply the gas sensor equipped with the gas sensor element 1 according to the first embodiment to various types of engines such as direct injection engines, turbo engines equipped with an exhaust gas turbine supercharger, and compressed natural gas engines.

As shown in FIG. 1, FIG. 3, and FIG. 4, the gas sensor element 1 is comprised of the solid electrolyte 11, the target gas electrode 12, the reference gas electrode 13, the porous diffusion resistance layer 14, the catalyst layer 2, a trap layer 3, and a shielding layer 15. The outer surface of the catalyst layer 2 is covered with the trap layer 3. This shielding layer 15 covers the upper surface of the porous diffusion resistance layer 14, as shown in FIG. 3, that is, covers the opposite surface to the surface of the porous insulation layer 14. The porous insulation layer 14 faces the surface of the solid electrolyte 11.

Further, as shown in FIG. 3, the gas sensor element 1 according to the first embodiment has a reference gas chamber forming layer 16 in order to form a reference gas chamber 160 at the reference gas electrode 13 side in the reference gas chamber forming layer 16. A reference gas is introduced into the inside of the reference gas chamber 160. As shown in FIG. 3, a heating layer 17, the reference gas chamber forming layer 16, the solid electrolyte 11, the porous diffusion resistance layer 14, and the shielding layer 15 are stacked to make a lamination body. This heating layer 17 contains heating substrate 170 equipped with a plurality of heating parts 171 therein. When receiving an electric power, the heating parts 171 generate heat energy.

A description will now be given of the gas sensor element 1 according to the first embodiment with reference to FIG. 1, FIG. 2, FIG. 3, and FIG. 4.

The gas sensor element 1 according to the first embodiment has the catalyst layer 2. This catalyst layer 2 is composed of a mixture made of the noble metal catalysts 21 having an average particle size within a range of 0.3 to 0.8 μm, and α-alumina 20 (Al₂O₃) of an average particle size within a range of 1.2 to 1.8 μm.

In the gas sensor element 1 according to the first embodiment, the noble metal catalysts 21 have an average particle size of 0.5 μm, and the α-alumina 20 (Al₂O₃) has an average particle size of 1.5 μm. There are known detection methods such as Laser diffraction/scattering method, and microtrack method.

As shown in FIG. 1, for example, it is possible for the gas sensor element 1 to have the catalyst layer 2 having the thickness d1 within a range of 1 to 15 μm. In the structure of the gas sensor element 1 according to the first embodiment, the catalyst 2 has the thickness d1 of 5 μm.

It is also possible for the gas sensor element 1 to have the catalyst layer 2 of a porosity within a range of 40 to 60%. In the structure of the gas sensor element 1 according to the first embodiment, the catalyst layer 2 has the porosity of 50%.

It is also possible for the gas sensor element 1 to have the catalyst layer 2 which further has borosilicate glasses 23 within a range of 12 to 40 mass % to the entire content of the catalyst layer 2. In the first embodiment, the catalyst layer 2 has borosilicate glasses 23 of 12 mass % to the entire content of the catalyst layer 2.

It is possible for the catalyst layer 2 to contain the noble metal catalysts 21 of an average particle size of 0.5 μm, for example. The noble metal catalysts 21 are composed of 10 mass % of rhodium, 45 mass % of palladium, and 45 mass % of platinum, for example.

It is also possible for the catalyst layer 2 to have the noble metal catalysts 21 within a range of 20 to 80 mass % to the entire content of the catalyst layer 2. In the gas sensor element 1 according to the first embodiment, the noble metal catalysts 21 has the content of 80 mass % to the entire content of the catalyst layer 2 in order to keep the stoichiometry accuracy and to maintain its durability. In other words, the gas sensor element 1 according to the first embodiment has the catalyst layer 2 which is made of material composed of the alumina particles 20 and the noble metal catalysts 21. This is different from a structure where a small amount of fine noble metal catalysts is supported on the alumina particles in the catalyst layer. H₂ gas contained in the target gas is fired in the catalyst layer 2 which will be explained later in detail.

The trap layer 3 in the gas sensor element 1 according to the first embodiment is made of alumina having an average particle size of 4 μm, for example. It is possible for the trap layer 3 to have the thickness d2 within a range of 10 to 400 μm. In the structure of the gas sensor element 1 according to the first embodiment, the trap layer 3 has the thickness d2 of 20 μm.

The trap layer 3 captures CO gas, NO gas, and CH₄ gas contained in a target gas to be detected. The trap layer 3 will be explained later.

As shown in FIG. 1, FIG. 3, and FIG. 4, the catalyst layer 2 is formed on the outer surface 141 of the porous diffusion resistance layer 14 through which the target gas is introduced into the inside of the gas sensor element 1. That is, one outer surface 142 of the porous diffusion resistance layer 14, through which no target gas is introduced, is covered with a dense shielding layer 15. Further, the other outer surface of the porous diffusion resistance layer 14, through which no target gas is introduced, is formed on the solid electrolyte 11. As shown in FIG. 3, the trap layer 3 is formed at the outer surface of the catalyst layer 2.

For example, the porous diffusion resistance layer 14 is made of alumina, and the average particle size of alumina which forms the porous diffusion resistance layer 14 is 1.5 μm, and a porosity of the porous diffusion resistance layer 14 is not more than 50% which is the porosity of the catalyst layer 2.

The average particle size of particles which form the porous diffusion resistance layer 14 can be measured by using SEM image of a cross section of the porous diffusion resistance layer 14. Porosity of the particles which form the porous diffusion resistance layer 14 can be measured by Mercury intrusion method using test pieces.

Still further, as shown in FIG. 1, in the gas sensor element 1 according to the first embodiment, it is possible for the porous diffusion resistance layer 14 to have the thickness d3 of 10 μm.

Still further, it is possible for the porous diffusion resistance layer 14 to have the average particle size within a range of 1.2 to 1.8 μm. This makes it possible for the catalyst layer 2 and the porous diffusion resistance layer 14 to have approximately the same porosity.

Next, a description will now be given of the method of producing the gas sensor element 1 according to the first embodiment with reference to FIG. 3 and FIG. 7. FIG. 7 is a flow chart showing the method of producing the gas sensor element 1 according to the present invention.

In step S1, ceramics sheets 814, 815, 811, 816, and 817 are prepared in order to form the porous diffusion resistance layer 14, the shielding layer 15, the solid electrolyte 11, the reference gas chamber forming layer 16, and the heating layer 17, respectively.

Next, the ceramics sheets 817, 816, 811, 814, and 815 are stacked to make a lamination (step S2). The lamination is then fired to make a lamination body 8 (step S3).

After step S3, a catalyst paste 82 is printed on an outer surface 141 of the ceramics sheet 814 of the porous diffusion resistance layer 14 in order to make the catalyst layer 2 (step S4). The catalyst paste 82 has noble metal catalysts which contain rhodium, platinum, and palladium. In particular, the average particle size of rhodium, platinum, and palladium is 0.5 μm.

Next, the lamination body 8 is immersed into a trap slurry to form the trap layer 3 on the outer surface of the catalyst paste 82 (step S5).

After this process, a thermal treatment of the lamination body 8 is performed to make the gas sensor element 1 according to the first embodiment of the present invention (step S6).

Next, a description will now be given of the functions of the catalyst layer 2 and the trap layer 3 with reference to FIG. 4.

FIG. 4 is a view to explain an introduction passage of a target gas to be detected into the inside of the gas sensor element 1 according to the first embodiment.

For example, the target gas emitted from an internal combustion engine contains H₂ gas. O₂ gas, CO gas, NO gas, and CH₄ gas. The target gas to be detected is introduced into the inside of the gas sensor element 1 through the introduction through holes 443 which are formed in the element cover case 44.

Next, the target gas passes through the trap layer 3, the catalyst layer 2, and the porous diffusion resistance layer 14, and finally reaches the target gas electrode 12 placed in the target gas electrode chamber 140. In particular, because H₂ gas has a high diffusion speed in the porous diffusion resistance layer 14, H₂ gas firstly reaches the target gas electrode 12 rather than the other gases contained in the target gas to be detected. This causes a possibility for the gas sensor element to cause an incorrect detection which is away from its true detection regarding a concentration of a specific gas contained in the target.

In the gas sensor element 1 according to the first embodiment of the present invention, the catalyst layer 2 has the noble metal catalysts 21 which contain rhodium, palladium, and platinum. Because this structure of the catalyst layer 2 adequately performs the combustion of H₂ gas contained in the target gas, it is possible for the gas sensor element 1 according to the first embodiment to output a correct detection signal, not to output any incorrect detection signal.

A description will now be given of the actions and effects of the gas sensor element 1 according to the first embodiment of the present invention.

The catalyst layer 2 of the gas sensor element 1 according to the present invention contains the noble metal catalysts 21 of the average particle size of not less than 0.3 μm. This makes it possible to provide the gas sensor element 1 having the catalyst layer 2 with superior high durability.

That is, noble metal catalysts of a small average particle size, for example, not more than 0.1 μm are supported in conventional gas sensor elements. In the prior art, it has been thought that using noble metal catalysts of a small average particle size, for example, not more than 0.1 μm, supported on ceramics such as alumina can adequately show its catalyst function. The reason why the noble metal catalysts of such a small size are used in the catalyst layer of the conventional gas sensor elements is as follows:

(a) The more the average particle size of noble metal catalyst is increased, the more the surface of the noble metal catalysts to show the catalyst activity is decreased; and

(b) Unless increasing the content of the noble metal catalysts, it becomes difficult to obtain an adequate catalyst activity.

However, noble metal catalysts of such a small size in the conventional gas sensor elements are coagulated and vaporized under the temperature environment to repeat cyclic thermal stress. The conventional gas sensor elements cannot maintain the durability of the catalyst layer.

On the other hand, the inventors according to the present invention have invented the gas sensor element having the catalyst layer with noble metal catalysts by changing the average particle size of the noble metal catalysts within a range of 0.3 to 0.8 μm which is different from the average particle size of the noble metal catalysts used in the conventional gas sensor elements. That is, using noble metal catalysts of a relatively large average particle size makes it possible to suppress the noble metal catalysts from being coagulated and vaporized under high temperature conditions. In other words, using the noble metal catalysts of the average particle size within an optimum range makes it possible to suppress the noble metal catalysts in the catalyst layer from being coagulated and vaporized under various severe conditions such as high temperature conditions. It is thereby possible for the present invention to provide the gas sensor element 1 having the catalyst layer 21 with superior high durability under various severe environments such as high temperature conditions.

Because the gas sensor element 1 according to the first aspect of the present invention has the catalyst layer 2 which contains the above noble metal catalysts 21 of a relatively large average particle size, it is possible to carry out an adequate combustion of H₂ gas contained in a target gas. Further, this makes it possible to prevent that the gas sensor equipped with the gas sensor element outputs an incorrect detection signal which is away from its true detection signal.

Further, because the noble metal catalysts 21 in the catalyst layer 2 have an average particle size of not more than 0.8 μm, it possible to form the catalyst layer of a relatively thin catalyst layer. This makes it possible to miniaturize the gas sensor element.

Using the noble metal catalysts 21 having an average particle size of not more than 0.8 μm makes it possible to obtain the actions and effects of the present invention without increasing the amount of the noble metal catalysts. This can suppress the cost to manufacture the gas sensor element 1.

Because the catalyst layer 2 is composed of the noble metal catalysts 21 and ceramics such as β-alumina, and the content of noble metal catalysts 21 to the entire content of the catalyst layer 2 is within a range of 20 to 80 mass %, it is possible for the catalyst layer 2 in the gas sensor element 1 to have an adequate area of the catalyst activity. As a result, this makes it possible to provide the gas sensor element 1 having the catalyst layer 2 with high durability, which is capable of preventing that the gas sensor equipped with the gas sensor element outputs an incorrect detection signal which is away from its true detection signal.

Further, the ceramics contained in the catalyst layer 2 in the gas sensor element 1 is α-alumina 20, it is possible for the catalyst layer 2 and the porous diffusion resistance layer 14 which is in contact with the catalyst layer 2 to approximately have the same thermal expansion coefficient. This can prevent the catalyst layer 2 from being separated from the porous diffusion resistance layer 14 based on a difference in thermal expansion coefficient between them.

In addition, because the α-alumina 20 has the average particle size within a range of 1.2 to 1.8 μm, it is possible to provide the gas sensor element 1 with superior response characteristics while maintaining the strength of the catalyst layer 2.

Because the catalyst layer 2 in the gas sensor element 1 has a porosity of not less than that of the porous diffusion resistance layer 14, this makes it possible to supply an adequate amount of the target gas to be detected to the inside of the porous diffusion resistance layer 14 after the target gas passes through the catalyst layer 2. It is thereby possible to provide the gas sensor element 1 with superior response characteristics.

Further, because the catalyst layer 2 contains borosilicate glasses within a range of 12 to 40 mass % to the entire content of the catalyst layer 2, this makes it possible to increase adhesion between the catalyst layer 2 and the porous diffusion resistance layer 14. As a result it is possible to prevent the catalyst layer 2 from being separated from the porous diffusion resistance layer 14.

The method of producing the gas sensor element 1 according to the first embodiment of the present invention uses the technique to form the catalyst layer 2 by printing the catalyst paste on the outer surface 141 of the porous diffusion resistance layer 14. This technique to print or apply the catalyst paste on the outer surface of the porous diffusion resistance layer 14 can easily form the catalyst layer 2 on a desired position. This makes it possible to easily produce the gas sensor element 1 having the catalyst layer 2 with superior high durability and low manufacturing cost.

The gas sensor 4 equipped with the gas sensor element 1 is mounted on various types of engines such as direct injection engines capable of directly injecting fuel into a combustion chamber, turbo engines equipped with an exhaust gas turbine supercharger, and compressed natural gas engines using compressed natural gas as fuel. Accordingly, it is possible for the gas sensor 4 to show the superior features of the gas sensor element 1 according to the present invention. That is, the above engines discharge an exhaust gas which usually contains H₂ gas. Mounting the gas sensor 4 equipped with the gas sensor element 1 according to the present invention on those engines can remarkably show the actions and effects of the present invention.

As described above, the present invention provides the gas sensor element 1 and the gas sensor 4 having the catalyst layer 2 which contains the noble metal catalysts 21 with high durability capable of avoiding outputting of an incorrect detection signal which is away from its true detection signal.

### Second Embodiment

A description will be given of the second embodiment to detect stoichiometry accuracy of gas sensor elements as experimental samples after durability test, where the experimental samples have different average particle size of noble metal catalysts in the catalyst layer shown in Table 1.

The noble metal catalysts in the catalyst layer in each of the experimental samples in the second embodiments have a different average particle size within a range of 0.1 to 0.8 μm.

In the second embodiment, the content of the noble metal catalysts to the entire content of the catalyst layer is an optional value within a range of 20 to 80 mass %.

The second embodiment detected a difference between an actual output (as a detection signal) and a theoretical value (as an output value) of each of the samples under stoichiometry atmosphere where oxidation gas and reduction gas have the same chemical equivalent. After this, the durability test of those samples was performed at 950° C. over 200 hours.

After this, the second embodiment was detected again the difference between the actual value and the theoretical value of each of the samples as the gas sensor elements under stoichiometry atmosphere.

As a result, the experimental results of the second embodiment are shown in the following Table 1, where “0” designates the difference from the correct value within a range of less than 20%, and “×” indicates the difference of not less than 20% after the durability test when the difference in a sample without catalyst layer is 100%.

TABLE 1

| | | Judgment results of |
|---|---|---|
| | Average particle size (μm) | stoichiometry accuracy |
| Sample | of noble metal catalysts | after durability test |
| 1 | 0.1 | X |
| 2 | 0.3 | ◯ |
| 3 | 0.5 | ◯ |
| 4 | 0.8 | ◯ |

As can be understood from Table 1, the judgment results in stoichiometry accuracy of the samples 2 to 4 where the noble metal catalysts in the catalyst layer have the average particle size of 0.3 μm after durability test indicates “◯”, and the catalyst layer of those samples 2 to 4 shows a superior performance.

On the other hand, the judgment result in stoichiometry accuracy of the sample 1 where the noble metal catalysts in the catalyst layer have the average particle size of less than 0.3 μm after durability test indicates “×”, and the catalyst layer of those samples 2 to 4 shows a decreased performance.

There is a possibility of it being difficult to form the catalyst layer of a relatively thin thickness when the noble metal catalysts have the average particle size of not less than 0.9 μm.

As described above, it is preferable for the catalyst layer to have the average particle size within a range of 0.3 to 0.8 μm in view of increasing the durability characteristics of the catalyst layer.

### Third Embodiment

A description will be given of a third embodiment of the present invention to detect the stoichiometry accuracy of the gas sensor element after durability test while changing the content of the noble metal catalysts in the catalyst layer.

The third embodiment used various types of samples as the gas sensor element where the content of the noble metal catalysts to the entire content of the catalyst layer was changed within a range of 10 to 80 mass %.

Like the procedure used in the second embodiment, the third embodiment carried out the durability test to each of the samples. Table 2 shows the experimental results of the third embodiment, where “⊚” designates the difference (from the true value) within less than 5%, “◯” denotes the difference within a range of not less than 5%. The samples used in the third embodiment have the average particle size of 0.3 μm.

TABLE 2

| | Content (mass %) of | |
|---|---|---|
| | noble metal catalyst | Judgment results of stoichiometry |
| Samples | in catalyst layer | accuracy after durability test |
| 1 | 1 | X |
| 2 | 15 | ◯ |
| 3 | 20 | ⊚ |
| 4 | 50 | ⊚ |
| 5 | 80 | ⊚ |

As can be understood from Table 2, the samples 3, 4, and 5 having the catalyst layer which contains not less than 20 mass % of the noble metal catalysts designated by “◯” have a good stoichiometry accuracy after durability test.

On the other hand, the sample 1 having the catalyst layer which contains less than 20 mass % of the noble metal catalysts designated by “◯” or “×” have a decreased stoichiornetry accuracy after durability test.

Accordingly, it is preferable for the gas sensor element to have the catalyst layer which contains not less than 20 mass % of the noble metal catalysts (like the samples 3, 4, and 5 in Table 2).

Although the third embodiment used the samples having the catalyst layer which contains the noble metal catalysts of the average particle size of 0.3 μm, it is possible to use the catalyst layer having not less than 0.3 μm average particle size in order to adequately have the actions and effects of the present invention, previously described.

### Fourth Embodiment

A description will be given of a fourth embodiment of the present invention where an adhesive degree of the catalyst layer on the porous diffusion resistance layer while changing the content of borosilicate glasses to the entire content of the catalyst layer as shown in FIG. 3.

That is, various types of pastes were prepared and printed on an alumina substrate as five types of samples, where the alumina substrate was the same materials of the porous diffusion resistance layer, and the printed paste on each of the alumina substrates is a square shape having an area of 10 mm². The content of borosilicate glasses in each of the five types of samples was within a range of 0 to 40 mass %. Those samples were baked at 900° C. for one hour.

A wire was fixed to the catalyst layer of each type of the samples by adhesion made of epoxy paste, where ten samples were prepared for each type of the samples.

The wire was pulled to detect the number of the samples where the catalyst layer was separated from the alumina substrate.

Further, tensile strength (N/m²) was detected when the catalyst layer was separated from the alumina substrate or when the adhesion was separated from the catalyst layer or the alumina substrate.

In the fourth embodiment, the catalyst layer had the noble metal catalysts of an average particle size of 0.5 μm. Table 3 shows the experimental results of the fourth embodiment.

TABLE 3

| | Added | Number or separated | Tensile |
|---|---|---|---|
| Types of | content (mass %) of | samples (in ten samples | strength |
| samples | borosilicate glasses | every each type) | (N/m²) |
| 1 | 0.0 | 10 | 34.3 |
| 2 | 6.0 | 10 | 39.2 |
| 3 | 12.0 | 0 | 58.8 |
| 4 | 20.0 | 0 | 57.9 |
| 5 | 40.0 | 0 | 60.8 |

As can be understood from the experimental results shown in Table 3, there are no separation between the alumina substrate and the catalyst layer in the samples (of the types 3, 4, and 5 in Table 3) where the content of borosilicate glasses is not less than 12 mass %. Those samples (of the types 3, 4, and 5 in Table 3) have a tensile strength of 58.8N which was detected when the adhesion is broken, in other words, the separation occurs in the adhesion.

On the other hand, the separation of the catalyst layer from the alumina substrate occurred in all of the samples (of types 1 and 2 in Table 3)) where the content of borosilicate glasses is less than 12 mass %. This clearly shows there is no adequate adhesion between the catalyst layer and the alumina substrate in those samples (of types 1 and 2 in Table 3).

Further, the catalyst layer was separated from the alumina substrate when the tensile strength becomes not more than 39.2 N in the samples of types 1 and 2 shown in Table 3. It cannot be said that those samples of types 1 and 2 have an adequate adhesive strength.

As describe above, it is preferable to add borosilicate glasses within a range of 12 to 40 mass % (to the entire content of the catalyst layer) into the catalyst layer in order to adequately adhesive the catalyst layer on the porous diffusion resistance layer in the gas sensor element.

Although the samples in the fourth embodiment use the noble metal catalysts of an average particle size of 0.3 μm, it can be understood to have the actions and effects of the present invention unless using noble metal catalysts of an average particle size of not less than 0.3 μm.

While specific embodiments of the present invention have been described in detail, it will be appreciated by those skilled in the art that various modifications and alternatives to those details could be developed in light of the overall teachings of the disclosure. Accordingly, the particular arrangements disclosed are meant to be illustrative only and not limited to the scope of the present invention which is to be given the full breadth of the following claims and all equivalents thereof.

What is claimed is:

1. A gas sensor element comprising:
a solid electrolyte with an oxygen ion conductivity;
a target gas electrode formed on one surface of the solid electrolyte, and a reference gas electrode formed on the other surface of the solid electrolyte;
a porous diffusion resistance layer surrounding the target gas electrode, through which the target gas passes and reaches the target gas electrode; and
a catalyst layer formed on an outer surface of the porous diffusion resistance layer, through which the target gas is introduced into the inside of the gas sensor element, the catalyst layer containing noble metal catalysts, and the noble metal catalysts having an average particle size of not less than 0.3 μm.

2. The gas sensor element according to claim 1, wherein the noble metal catalysts in the catalyst layer have the average particle size within a range of 0.3 to 0.8 μm.

3. The gas sensor element according to claim 1, wherein the content of the noble metal catalysts is not less than 20 mass % to the entire content of the catalyst layer.

4. The gas sensor element according to claim 3, wherein the catalyst layer is made of the noble metal catalysts and α-alumina, where the content of the noble metal catalysts is within a range of 20 to 80 mass % to the entire content of the catalyst layer.

5. The gas sensor element according to claim 4, wherein the α-alumina has an average particle size within a range of 0.5 to 2.0 μm.

6. The gas sensor element according to claim 1, wherein a porosity of the catalyst layer is not less than a porosity of the porous diffusion resistance layer.

7. The gas sensor element according to claim 1, wherein the catalyst layer is made of at least 12 to 40 mass % of borosilicate glasses to the entire content of the catalyst layer.

8. A gas sensor equipped with the gas sensor element therein according to claim 1 and capable of detecting a concentration of a specific gas contained in the target gas.

9. The gas sensor according to claim 8 to be applied to one of direct injection engines to directly inject fuel into combustion chambers, turbo engines equipped with an exhaust gas turbine supercharger, and compressed natural gas engines using compressed natural gas.

10. A method of producing a gas sensor element, comprising steps of:
preparing ceramics sheets to form a porous diffusion resistance layer, a shielding layer, a solid electrolyte, a reference gas chamber forming layer, and a heating layer;
stacking those ceramics sheets to make a lamination;
firing the lamination to make a lamination body;
printing a catalyst paste on an outer surface of the ceramics sheet of the porous diffusion resistance layer in order to make a catalyst layer,
immersing the lamination into a trap slurry to form a trap layer on the outer surface of the catalyst paste; and
performing thermal treatment of the lamination to make a gas sensor element.

11. The method of producing a gas sensor element according to claim 10, wherein the noble metal catalysts contained in the catalyst paste have an average particle size of not less than 0.3 μm.

12. The method of producing a gas sensor element according to claim 10, wherein the noble metal catalysts contained in the catalyst paste have the average particle size within a range of 0.3 to 0.8 μm.

13. The method of producing a gas sensor element according to claim 10, wherein the content of the noble metal catalysts in the catalyst paste is determined so that the content of the noble metal catalysts is not less than 20 mass % to the entire content of the catalyst layer.

14. The method of producing a gas sensor element according to claim 10, wherein the catalyst paste is made of the noble metal catalysts and α-alumina so that the content of the noble metal catalysts is within a range of 20 to 80 mass % to the entire content of the catalyst layer.

15. The method of producing a gas sensor element according to claim 14, wherein the α-alumina in the catalyst paste has an average particle size within a range of 0.5 to 2.0 μm.

16. The method of producing a gas sensor element according to claim 10, wherein the catalyst paste is used so that a porosity of the catalyst layer is not less than a porosity of the porous diffusion resistance layer.

17. The method of producing a gas sensor element according to claim 10, wherein the catalyst paste is used so that the catalyst layer is made of at least 12 to 40 mass % of borosilicate glasses to the entire content of the catalyst layer.
